(19) United States
(12) Patent Application Publication
(10) Pub. No.: US 2026/0361578 A1
(43) Pub. Date: Nov. 12, 2026

(54) DOUBLE THRESHOLD BIPHASE MARK CODE DECODER

(71) Applicant: STMicroelectronics International N.V., Geneva (CH)

(72) Inventors: Raffaele Elefante, Pavia (IT); Roberta Priolo, Milano (IT)

(21) Appl. No.: 19/205,453

(22) Filed: May 12, 2025

(51) Int. Cl. H04L 27/233

(52) U.S. Cl. CPC H04L 27/2334

(57) ABSTRACT

A method of decoding a biphase mark code (BMC) encoded signal includes setting a previous flag according to a third most recent interval and a second most recent interval, setting a new flag according to the second most recent interval and a first most recent interval, and decoding a new bit of the BMC encoded signal according to the previous flag and the new flag. The third most recent interval separates a first transition and a second transition of the BMC encoded signal. The second most recent interval separates the second transition and a third transition of the BMC encoded signal. The first most recent interval separates the third transition and a fourth transition of the BMC encoded signal. A BMC decoder circuit that includes lower and upper threshold circuits and a state machine circuit may be used to perform the method.

### TECHNICAL FIELD

The present invention relates generally to serial communication, and, in particular embodiments, to systems and methods for serial communication using biphase mark code encoded signals.

### BACKGROUND

Serial communication forms the foundation of numerous modern technological systems, enabling the exchange of data between devices across various mediums. In wireless serial communication, electromagnetic waves carry digital information through free space, allowing for mobility and eliminating physical connections. Wired serial communication, conversely, transmits data sequentially over physical transmission lines (such as electrical conductors, fiber optics, etc.), offering reliable connections in environments where wireless signals may face interference. Clock recovery mechanisms ensure that receivers properly synchronize with incoming data streams by extracting timing information from the signal itself. Signal decoding techniques, including Phase-Shift Keying (PSK), translate these timed signals back into the original binary information by analyzing shifts in signal properties.

Biphase Mark Code (BMC) encoding offers several advantages over alternative encoding schemes such as Manchester encoding. While both provide self-clocking capabilities, BMC requires less bandwidth and offers improved noise immunity. In BMC, each bit period contains a guaranteed transition at the beginning, with one bit value (e.g., logical '1' bits) having an additional mid-bit transition and the other bit value (e.g., logical '0' bits) having no additional transition. This encoding pattern ensures that there is a transition at the beginning and end of each bit allowing for reliable clock recovery while maintaining DC balance, making it suitable for transformer-coupled or capacitively-coupled systems. BMC also provides inherent error detection capabilities, as missing transitions at bit boundaries can immediately signal potential transmission errors.

The BMC encoding process follows specific rules where each bit period begins with a transition, and the presence or absence of a mid-bit transition determines the bit value. In typical implementations, communication packets begin with a preamble consisting of consecutive bits having the same value (e.g., consecutive '1' bits), followed by a start bit (e.g., a '0' bit), a data byte, a parity bit for error detection, and finally a stop bit (e.g., a '1' bit). This structured approach to data transmission provides synchronization, framing, and basic error detection capabilities within the encoding scheme itself.

Wireless power transfer systems, such as those conforming to the Qi standard, utilize BMC encoding for communication between power transmitters and receivers. In these applications, the power receiver modulates its load to create detectable variations in the power transmitter's current or voltage, effectively sending data back to the transmitter without requiring a separate communication channel. This backscatter communication method allows the receiver to communicate its power requirements, device identification, and status information while simultaneously receiving power. Current Qi standard implementations operate with bit rates up to 20 kHz, with potential future increases to 40 kHz or higher, placing increasing demands on the decoding systems to maintain reliability at higher data rates.

### SUMMARY

In accordance with an embodiment of the invention, a method of decoding a biphase mark code (BMC) encoded signal includes setting a previous flag according to a third most recent interval and a second most recent interval, setting a new flag according to the second most recent interval and a first most recent interval, and decoding a new bit of the BMC encoded signal according to the previous flag and the new flag. The third most recent interval separates a first transition and a second transition of the BMC encoded signal. The second most recent interval separates the second transition and a third transition of the BMC encoded signal. The first most recent interval separates the third transition and a fourth transition of the BMC encoded signal.

In accordance with another embodiment of the invention, a BMC decoder circuit includes a lower threshold circuit configured to compare a new flag interval to a lower threshold to generate a lower threshold output signal, an upper threshold circuit configured to compare the new flag interval to an upper threshold to generate an upper threshold output signal, and a BMC state machine circuit configured to set a new flag according to the lower threshold output signal and the upper threshold output signal, and to decode a new bit of a BMC encoded signal according to a previous flag and the new flag. The new flag interval is determined using a second most recent interval and a first most recent interval. The second most recent interval separates a first transition and a second transition of the BMC encoded signal. The first most recent interval separates the second transition and a third transition of the BMC encoded signal.

In accordance with still another embodiment of the invention, a demodulator circuit includes a signal processing circuit including an analog-to-digital converter (ADC) circuit, and a BMC decoder circuit. The signal processing circuit is configured to receive a modulated BMC encoded signal and output a digital BMC encoded signal. The BMC decoder circuit is configured to set a previous flag according to a third most recent interval and a second most recent interval, set a new flag according to the second most recent interval and a first most recent interval, and decode a new bit of the digital BMC encoded signal according to the previous flag and the new flag. The third most recent interval separates a first transition and a second transition of the digital BMC encoded signal. The second most recent interval separates the second transition and a third transition of the digital BMC encoded signal. The first most recent interval separates the third transition and a fourth transition of the digital BMC encoded signal.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a schematic timing diagram of an example biphase mark code (BMC) encoded signal showing four transitions defining three time intervals that form a new flag interval and a previous flag interval in accordance with embodiments of the invention;

FIG. 2 illustrates schematic timing diagrams of example BMC encoded signals showing each possible pair of consecutive time intervals and the corresponding flag intervals grouped in three categories through comparison with a lower threshold and an upper threshold in accordance with embodiments of the invention;

FIG. 3 illustrates schematic timing diagrams showing each possible scenario for the new flag when the previous flag is SHORT to demonstrate an example method of decoding a new bit of a BMC encoded signal in accordance with embodiments of the invention;

FIG. 4 illustrates schematic timing diagrams showing each possible scenario for the new flag when the previous flag is MEDIUM to demonstrate an example method of decoding a new bit of a BMC encoded signal in accordance with embodiments of the invention;

FIG. 5 illustrates schematic timing diagrams showing each possible scenario for the new flag when the previous flag is LONG to demonstrate an example method of decoding a new bit of a BMC encoded signal in accordance with embodiments of the invention;

FIG. 6 illustrates a table summarizing the decoded values of the previous bit and the new bit for each possible pair of consecutive flags using a first type of BMC encoding in accordance with embodiments of the invention;

FIG. 7 illustrates a table summarizing the decoded values of the previous bit and the new bit for each possible pair of consecutive flags using a second type of BMC encoding in accordance with embodiments of the invention;

FIG. 8 illustrates a schematic block diagram of an example BMC decoder circuit that includes a lower threshold circuit, an upper threshold circuit, and a BMC state machine circuit configured to decode bits of a BMC encoded signal according to pairs of flags set according to a lower threshold and an upper threshold in accordance with embodiments of the invention;

FIG. 9 illustrates a schematic block diagram of an example receiver that includes a signal processing circuit and a BMC decoder circuit configured to decode bits of a BMC encoded signal according to pairs of flags set according to a lower threshold and an upper threshold in accordance with embodiments of the invention;

FIG. 10 illustrates an example method of decoding a BMC encoded signal that includes setting a previous flag according to third and second most recent intervals between transitions of the BMC encoded signal, setting a new flag according to second and first most recent intervals of the BMC encoded signal, and decoding a new bit of the BMC encoded signal according to the previous flag and the new flag in accordance with embodiments of the invention; and

FIG. 11 illustrates the two types of decoding for a BMC encoded signal and the corresponding compliment BMC encoded signal.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

BMC decoding may be used in PSK and PSK-like demodulation, that can occur in a variety of communication contexts, including during communication between power receiver and power transmitter in wireless power transfer systems. According to the Qi standard for wireless power transfer, communication between the power receiver and the power transmitter exploits BMC encoding, synchronized with a clock signal with frequency f _{CLK} = 2±4% kHz (also corresponding to the bitrate). That is, current bitrate is 20 kHz with higher frequencies (e.g., 40 kHz) possible in the future.

Differently from traditional Manchester encoding, where 0 and 1 are encoded onto falling and rising edges respectively (IEEE 802.4), BMC encoding shows a systematic edge at the beginning of each clock period and 0 and 1 are associated with the absence or presence of an intermediate transition after the falling edge of the clock signal. In other words, in a time window equal to the bit period, one bit value (e.g., a ‘0’ bit) is a rectangular pulse, while the other bit value (e.g., a ‘1’ bit) is a square wave. The preamble may be given by a sequence of consecutive 1’s (whose number may vary and may be based in some part on the bitrate in practical applications). Then, the message may begin with a start bit (always 0 in this example), then one data byte, then a parity bit (set to 1 if the data byte contains an even number of 1 bits), and then finally a stop bit (always 1 in this example).

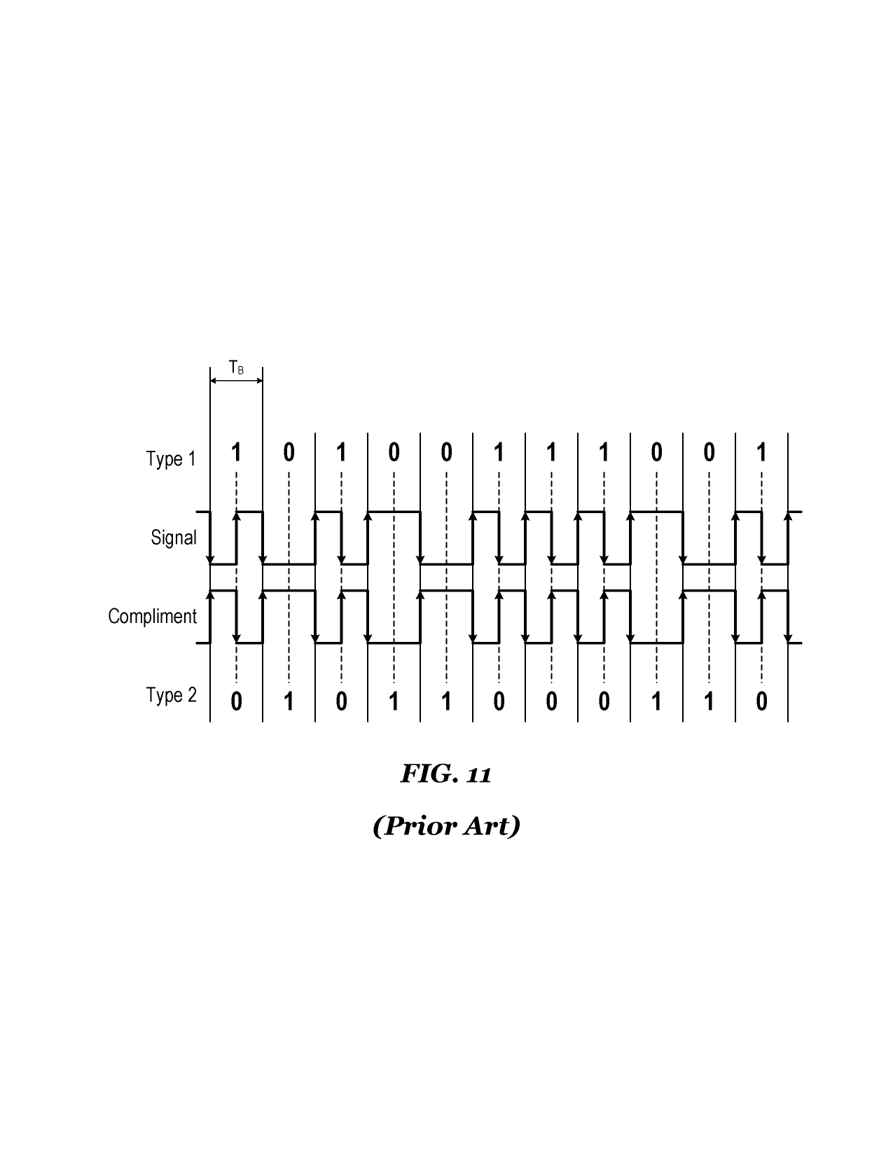

FIG. 11 illustrates the two types of decoding for a BMC encoded signal and the corresponding compliment BMC encoded signal. As shown, the BMC encoded signal and the compliment BMC encoded signal result in the same bitstream. Each bit has the same duration T_{B} in the BMC encoded signal. This duration is synchronized with the clock signal (e.g., in a 1:1 ratio, for example). The designation of which pattern is decoded as a ‘0’ bit and which pattern is decoded as a ‘1’ bit is optional, resulting in two types of decoding. For example, the BMC encoded signal and the compliment BMC encoded signal result in the bit pattern 10100111001 for a first type of BMC encoding, a transition within the BMC bit duration T_{B} indicates a ‘1’ bit and no transition indicates a ‘0’ bit. Conversely, for a second type of BMC encoding where a mid-bit transition indicates a ‘0’ bit and no transition indicates a ‘1’ bit, the resulting bit pattern is 01011000110.

Noisy signals can present a problem for BMC encoded signals. For example, when electromagnetic interference, thermal noise, or other signal distortions affect the BMC waveform, the precise timing of transitions can be altered, creating ambiguity in edge detection. Since BMC decoding relies heavily on accurate identification of signal transitions at specific time intervals, even minor timing variations can lead to erroneous bit interpretations. The problem may become more pronounced at higher bitrates, where the absolute time difference between a “full” and a “half” interval diminishes. This may make the decoder more susceptible to noise-induced errors.

In wireless power transfer applications, additional complications arise from load variations, coupling fluctuations, and power conversion artifacts that can further distort the communication signal. Conventional single-threshold decoders lack robustness in these noisy environments because they make binary decisions based on isolated measurements without considering the context of surrounding signal behavior, potentially leading to cascading decoding errors throughout the data packet.

One possible solution is to elaborate the encoded data with an amplitude shift keying (ASK) decoder that combines hardware and firmware. The hardware measures the time duration of the signal level between two edges (edge detection and a distance counter) and sends this information to the processor (e.g., a microprocessor) that executes a comparison algorithm to decode the signal. There are drawbacks to this solution, such as low robustness and a limit on execution time that is due to the firmware.

Another possible solution is to implement phase-locked loop (PLL) decoding. The PLL block is made of two parts: (1) PLL synchronization logic with (a) a programmable enable flag to sync on full/half-bit boundaries, (b) similarity threshold for full/half-bit intervals, (c) acceptable correction threshold, and (2) PLL sampling to score computation and bit decoding logic with (a) programmable coefficients for eight 7-tap finite impulse response (FIR) filters and (b) mux selector for input. There are also drawbacks to this solution, such as high complexity, high risk, and more area required for implementation.

Aspects of this disclosure present a double threshold decoding scheme for BMC encoded signals that offers enhanced robustness against noise and improved error correction capabilities. The double threshold approach correlates the current duration measurement between signal transitions (i.e., a most recent time interval Tₙ) with the two preceding measurements (second and third most recent time intervals T_{n−1} and T_{n−2}), establishing a relationship that can both decode the BMC encoded signal and compensate for transmission errors. Unlike conventional single threshold decoders that simply compare the period between edges with a fixed value, this approach categorizes pairs of duration measurements into three distinct groups (intuitively labeled SHORT, MEDIUM, and LONG and referred to herein as flags) using two threshold values (a lower threshold Th₁ and an upper threshold Th₂). A pair of flags (a new flag and a previous flag) is evaluated to determine the binary value of each bit in the BMC encoded signal.

In various embodiments, the double threshold decoder includes specialized hardware components such as edge detection circuitry, time interval measurement circuits, threshold comparison logic, and a state machine that tracks the relationship between consecutive measurements. The system may store previous duration values in memory elements to facilitate the correlation between current and past measurements. This correlation-based approach distributes potential errors across multiple measurements, allowing noise effects to potentially cancel each other out rather than accumulating.

The double threshold BMC decoder can be particularly effective in applications with high sampling rates that are susceptible to noise interference. When implemented in wireless power transfer systems, the decoder can maintain reliable communication between power transmitters and receivers even as data rates increase. The approach may use a sufficiently high sampling rate, such at least 8 samples per bit period, to accurately establish threshold values at approximately 25% of the bit period.

In one or more embodiments, the decoder may be integrated into an IQ demodulator system for wireless communication, working alongside components such as mixers, filters, and slicers to extract the original binary data from modulated signals. The double threshold technique can also be applied to wired communication systems where noise immunity and reliable clock recovery are important considerations. These and additional details are further discussed below.

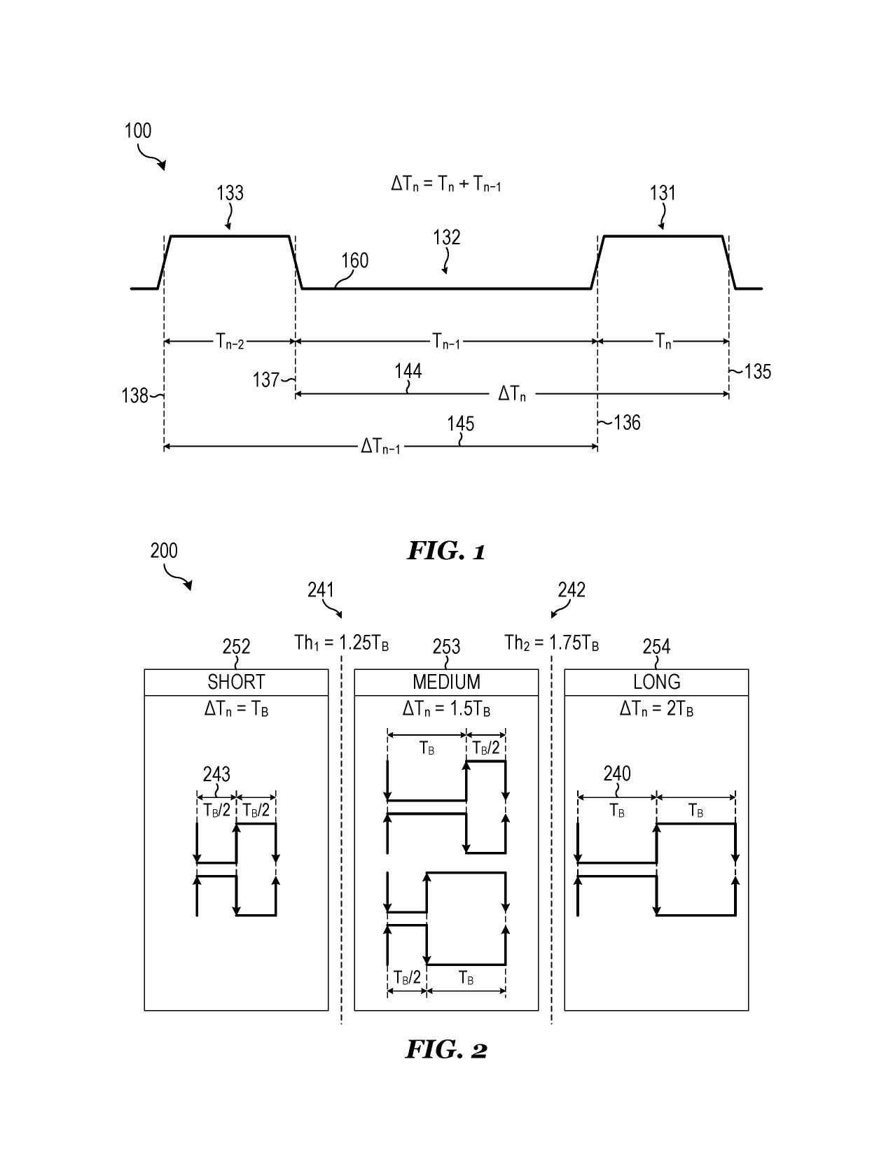

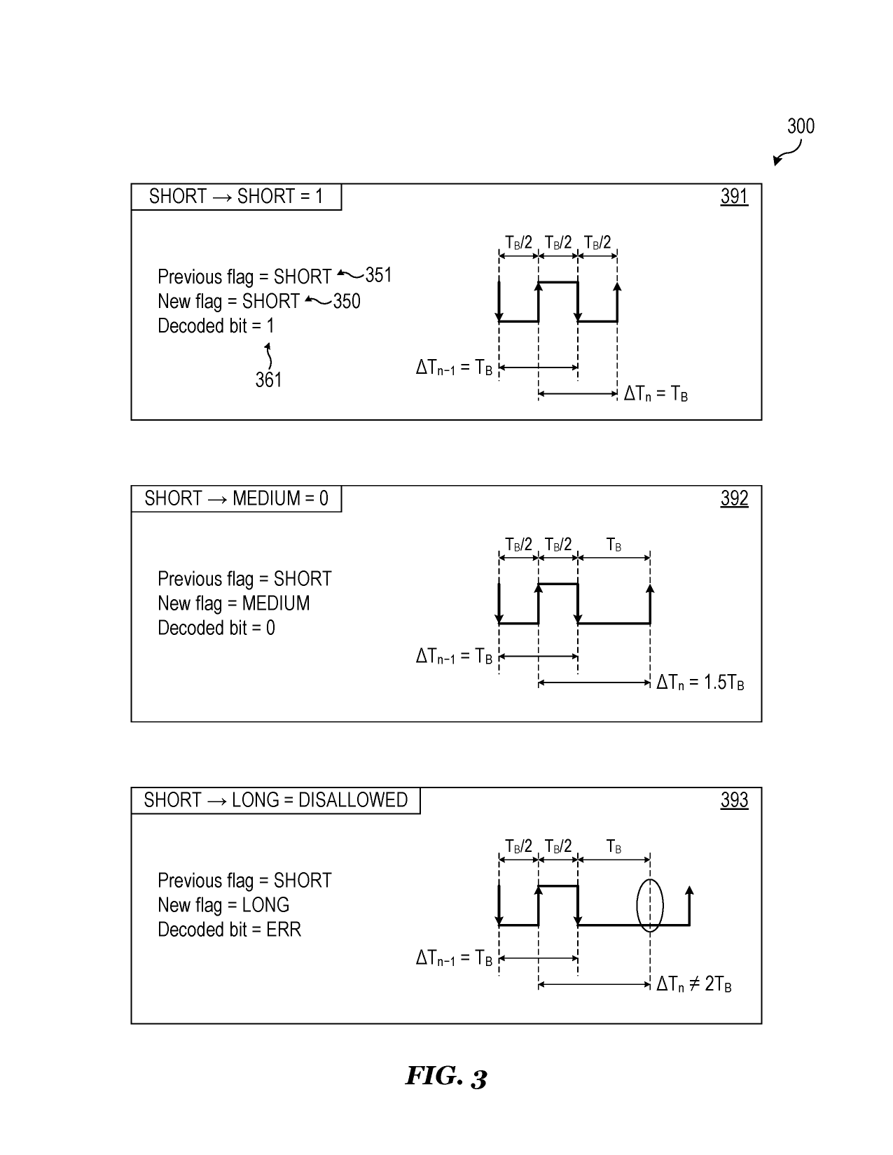

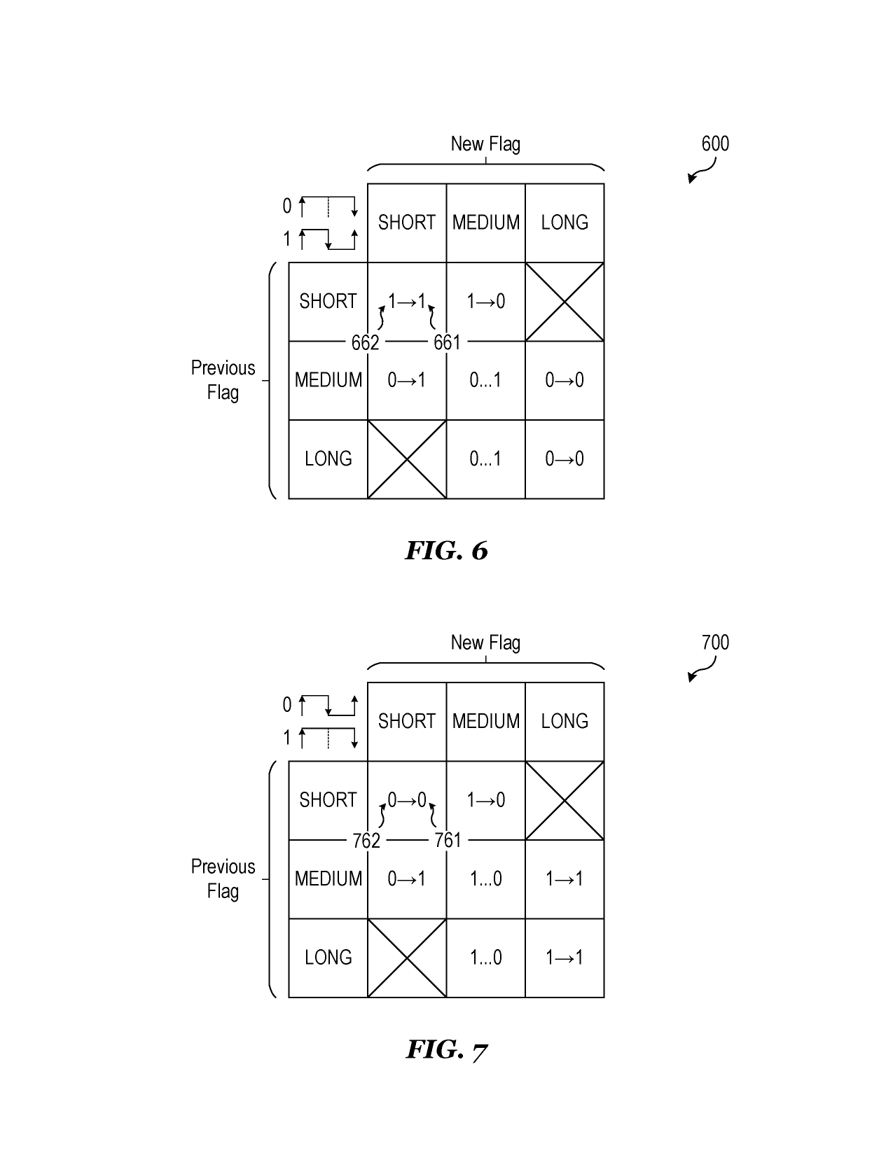

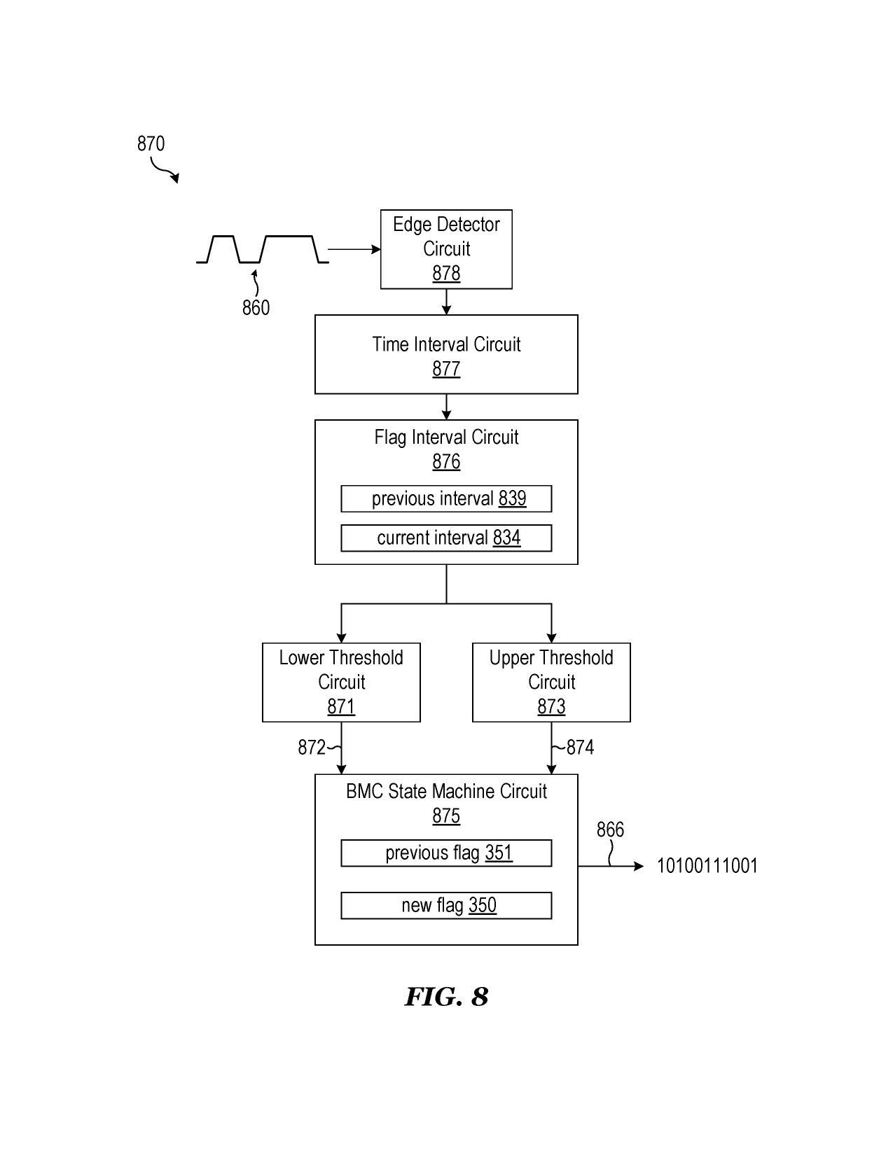

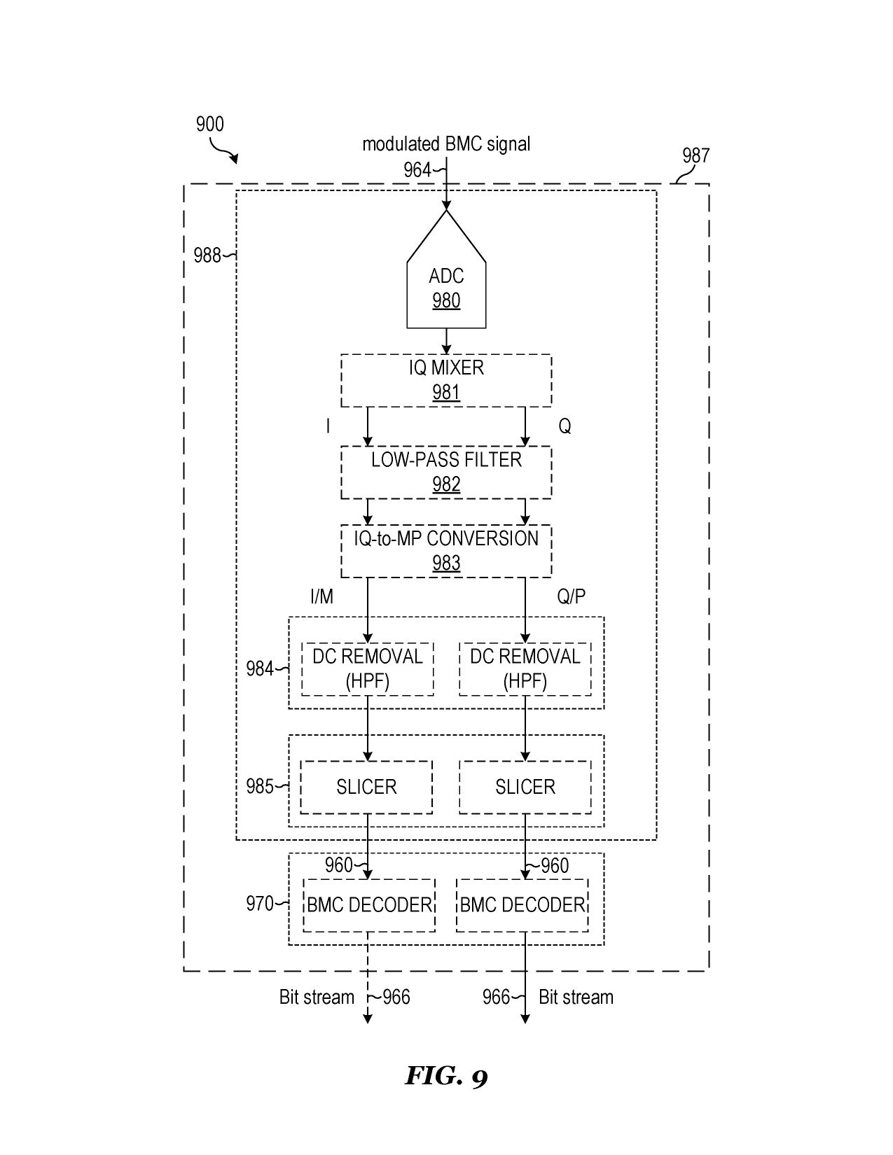

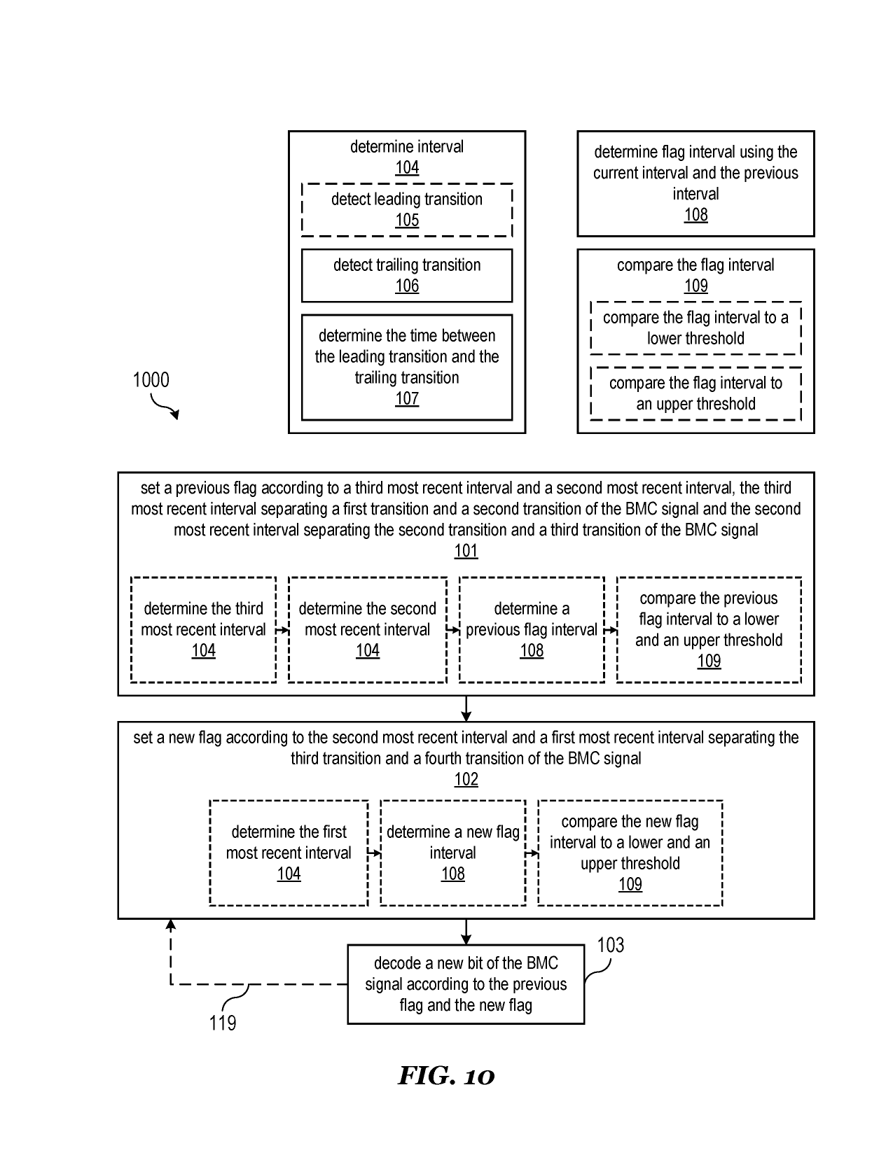

Embodiments provided below describe various circuits, systems, and methods for decoding a BMC encoded signal, and in particular embodiments, circuits, systems, and methods that use a double threshold comparison. The following description describes the embodiments. FIG. 1 is used to describe an example BMC encoded signal showing flag intervals ΔTₙ and ΔT_{n−1}. FIG. 2 is used to describe example BMC encoded signals showing possible pair of consecutive time intervals. The nine possible combinations of consecutive flags demonstrating an example method of decoding a new bit of a BMC encoded signal are described using FIGS. 3–5. Two tables summarizing decoding a previous bit and a new bit of a BMC encoded signal are described using FIGS. 6 and 7. An example BMC decoder circuit is described using FIG. 8 while an example receiver including a BMC decoder circuit is described using FIG. 9. An example method of decoding a BMC encoded signal is described using FIG. 10.

FIG. 1 illustrates a schematic timing diagram of an example BMC encoded signal showing four transitions defining three time intervals that form a new flag interval and a previous flag interval in accordance with embodiments of the invention.

Referring to FIG. 1, a timing diagrams 100 shows a BMC encoded signal 160 that has four transitions, labeled beginning with the most recent transition (the n transition 135 where n indicates the n^{th} transition of the BMC encoded signal 160 located somewhere in the bitstream, but at least the fourth (n =4) transition. The next three most recent transitions of the BMC encoded signal 160 are shown as n-1 transition 136, n-2 transition 137, and n-3 transition 138, the BMC encoded signal 160 potentially continuing in either or both directions.

The duration between consecutive transitions may be referred to as a time interval, and the four transitions shown in the BMC encoded signal 160 define three time intervals: n interval 131, n-1 interval 132, n-2 interval 133 where n again represents a current location somewhere in the bitstream. For purposes of readability and comprehension, the n interval 131, the n-1 interval 132, and the n-2 interval 133 may be referred to throughout this disclosure as Tₙ, T_{n−1}, and T_{n−2}, respectively.

The time intervals may then be combined to form so-called flag intervals ΔTₙ, which may be determined by summing two or more recent time intervals (ΔTₙ =Tₙ + T_{n−1}). For example, a new flag interval 144 may be determined using the most recent interval Tₙ and the second most recent interval T_{n−1} while a previous flag interval 145 may be determined using the second most recent interval T_{n−1} and the third most recent interval T_{n−2}.

FIG. 2 illustrates schematic timing diagrams of example BMC encoded signals showing each possible pair of consecutive time intervals and the corresponding flag intervals grouped in three categories through comparison with a lower threshold and an upper threshold in accordance with embodiments of the invention.

Referring to FIG. 2, timing diagrams 200 show the four possible combinations (and their corresponding compliments) of consecutive intervals for the BMC encoded signal 160. Specifically, the BMC encoded signal 160 includes a transition at the beginning and end of every BMC bit duration 240, which will be referred to as T_{B} throughout this disclosure. Each bit encoded in the BMC encoded signal 160 either includes an additional transition (i.e., a mid-bit transition) or has no transition. For this reason, the only allowed intervals are T_{B} and a half BMC duration 243 (T_{B}/2).

When pairs of intervals are combined to form flag intervals, the result is three possible categories (i.e., durations) of flag interval, which can be labeled as a first label 252 (SHORT), a second label 253 (MEDIUM), and a third label 254 (LONG). Of course the names of the labels are arbitrary and a chosen as such here for intuitive purposes. The first label 252 (SHORT) results from two half durations, and the third label 254 (LONG results from two full durations. Since T_{B} + T_{B}/2 = T_{B}/2 + T_{B} = 1.5T_{B}, the second label 253 (MEDIUM) results from the remaining possibilities.

The previous flag 351 is set according to a third most recent interval (n-2 interval 133) and a second most recent interval (n-1 interval 132). The third most recent interval separates a first transition (n-3 transition 138) and a second transition (n-2 transition 137) of the BMC encoded signal 160 while the second most recent interval separates the second transition (n-2 transition 137) and a third transition (n-1 transition 136) of the BMC encoded signal 160. In turn, the new flag 350 is set according to the second most recent interval (n-1 interval 132) and a first most recent interval (n interval 131) that separates the third transition (n-1 transition 136) and a fourth transition (n transition 135) of the BMC encoded signal 160.

One way of correlating the new flag 350 and the previous flag 351 with the pairs of recent intervals is to determine flag intervals (e.g., extended intervals). For example, the previous flag interval 145 may be determined as equal to the sum of the third most recent interval (n-2 interval 133) and the second most recent interval (n-1 interval 132). A double threshold comparison may then be made to compare the previous flag interval 145 to the lower threshold 241 and the upper threshold 242. Similarly, the new flag interval 144 may be determined as equal to the sum of the second most recent interval (n-1 interval 132) and the first most recent interval (n interval 131). A double threshold comparison may also be made to compare the new flag interval 144 to the lower threshold 241 and the upper threshold 242.

It should be noted that if the previous flag interval 145 or the new flag interval 144 are lower than the lower threshold 241, then it can be assumed that the respective flag interval also lower than the upper threshold 242 and the actual comparison to the upper threshold 242 may be omitted while still considering the respective flag interval to have been compared to the upper threshold 242 (and vice versa). Additionally, both the lower threshold 241 and the upper threshold 242 are greater than the BMC bit duration 240 of the BMC encoded signal 160.

As already discussed, the actual labels of the flags are arbitrary. Each respective flag may be set to one of three labels. For example, a respective flag may be set to the first label 252 (SHORT) when the respective flag interval is less than or equal to the lower threshold 241. Similarly, the respective flag may be set to the second label 253 (MEDIUM) when the respective flag interval is between the lower threshold 241 and the upper threshold 242, and the respective flag may be set to the third label 254 (LONG) when the respective flag interval is greater than or equal to the upper threshold 242.

The new flag interval (i.e., the current flag interval) can be categorize using a double threshold comparison step. Specifically, the new flag interval is compared to a lower threshold 241 and an upper threshold 242 to determine the category of the new flag. Because the lowest possible flag interval duration is ΔTₙ= T_{B}/2 + T_{B}/2 = T_{B}, the lower threshold 241 is greater than T_{B}. In one embodiment, the lower threshold 241 is about 1.25T_{B}. Similarly, the highest possible flag duration interval is ΔTₙ= T_{B} + T_{B} = 2T_{B} so the upper threshold 242 is less than 2T_{B}. In one embodiment, the upper threshold 242 is about 1.75T_{B}.

FIG. 3 illustrates schematic timing diagrams showing each possible scenario for the new flag when the previous flag is SHORT to demonstrate an example method of decoding a new bit of a BMC encoded signal in accordance with embodiments of the invention. The schematic timing diagrams of FIG. 3 may correspond to methods steps of any of the methods described herein, such as the method of FIG. 10, for example.

Referring to FIG. 3, timing diagrams 300 show the sequence of a previous flag 351 and a new flag 350 as (SHORT, SHORT) in box 391, the sequence of the previous flag 351 and the new flag 350 as (SHORT, MEDIUM) in box 392, and the sequence of the previous flag 351 and the new flag 350 as (SHORT, LONG) in box 393.

Referring to the box 391, it is shown that when the previous flag is short (ΔT_{n−1}= T_{B}) the middle interval is T_{B}/2. The most recent interval also has to be T_{B}/2 so the decoded bit (new bit 361) is ‘1’. It should be noted that for the examples of FIGS. 3–5, the BMC encoding type is such that a ‘1’ is decoded with a mid-bit transition occurs. In contrast, when the new flag is MEDIUM, the middle interval being T_{B}/2 requires the most recent interval to be T_{B} and the decoded bit is ‘0’, as shown in the box 392.

The sequence of (SHORT, LONG) is disallowed because there is no way for the flag interval to be 2T_{B} when one of the constituent intervals is T_{B}/2 as shown. Such a scenario would result in the lack of a transition at the end of the BMC bit duration. In such a case, a decoder performing the method may throw an error instead of decoding a bit, as shown in the box 393.

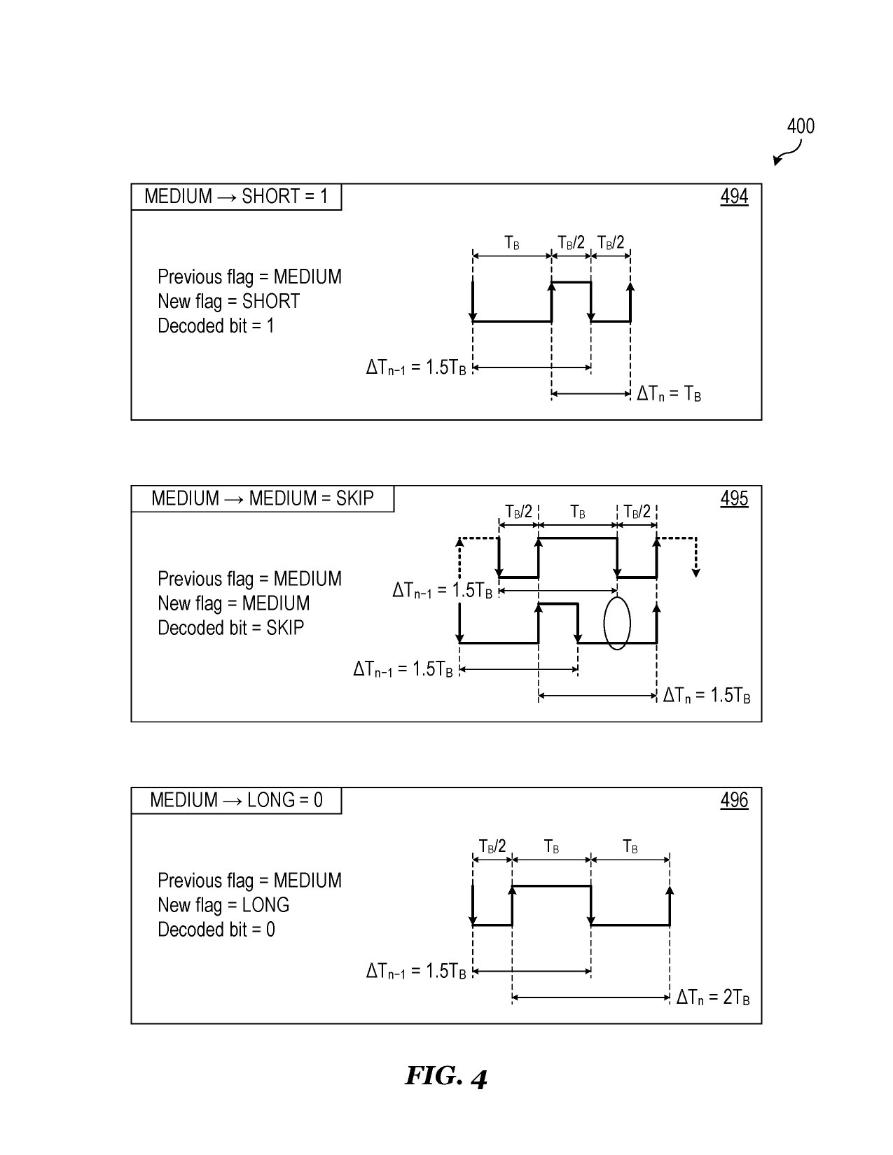

FIG. 4 illustrates schematic timing diagrams showing each possible scenario for the new flag when the previous flag is MEDIUM to demonstrate an example method of decoding a new bit of a BMC encoded signal in accordance with embodiments of the invention. The schematic timing diagrams of FIG. 4 may correspond to methods steps of any of the methods described herein, such as the method of FIG. 10, for example.

Referring to FIG. 4, timing diagrams 400 show the sequence of the previous flag and the new flag as (MEDIUM, SHORT) in box 494, the sequence of the previous flag and the new flag as (MEDIUM, MEDIUM) in box 495, and the sequence of the previous flag and the new flag as (MEDIUM, LONG) in box 496.

In the box 494, it is shown that the new flag being SHORT (ΔTₙ = T_{B}) requires that the middle interval be equal to T_{B}/2 so the decoded bit is ‘1’. Conversely, as shown in the box 496, the new flag being LONG (ΔTₙ = 2T_{B}) requires that the most recent interval be T_{B} so the decoded bit is ‘0’.

The box 495 shows the (MEDIUM, MEDIUM) sequence, which has two possible arrangements. The lower possibility is disallowed because a required transition at the end of a bit duration would be skipped, as shown. The top possibility shows that when the new flag is MEDIUM and the previous flag is MEDIUM the waveform of a new bit has not yet been received. Therefore, in one embodiment, a decoder performing the method skips decoding a bit for the new flag and continue the method.

However, it can also be seen that the next interval after a (MEDIUM, MEDIUM) must be T_{B}/2 to ensure that there is a transition at the end of the bit duration.. Therefore, in another embodiment, a decoder performing the method decodes a ‘1’ for the new bit and skips decoding a bit for the following transition. Additionally, it can be seen that the fourth most recent interval must also be T_{B}/2 giving the sequence of (SHORT, MEDIUM, MEDIUM, SHORT) resulting in a bit pattern of 101 as the only possible context within which the (MEDIUM, MEDIUM) sequence can exist.

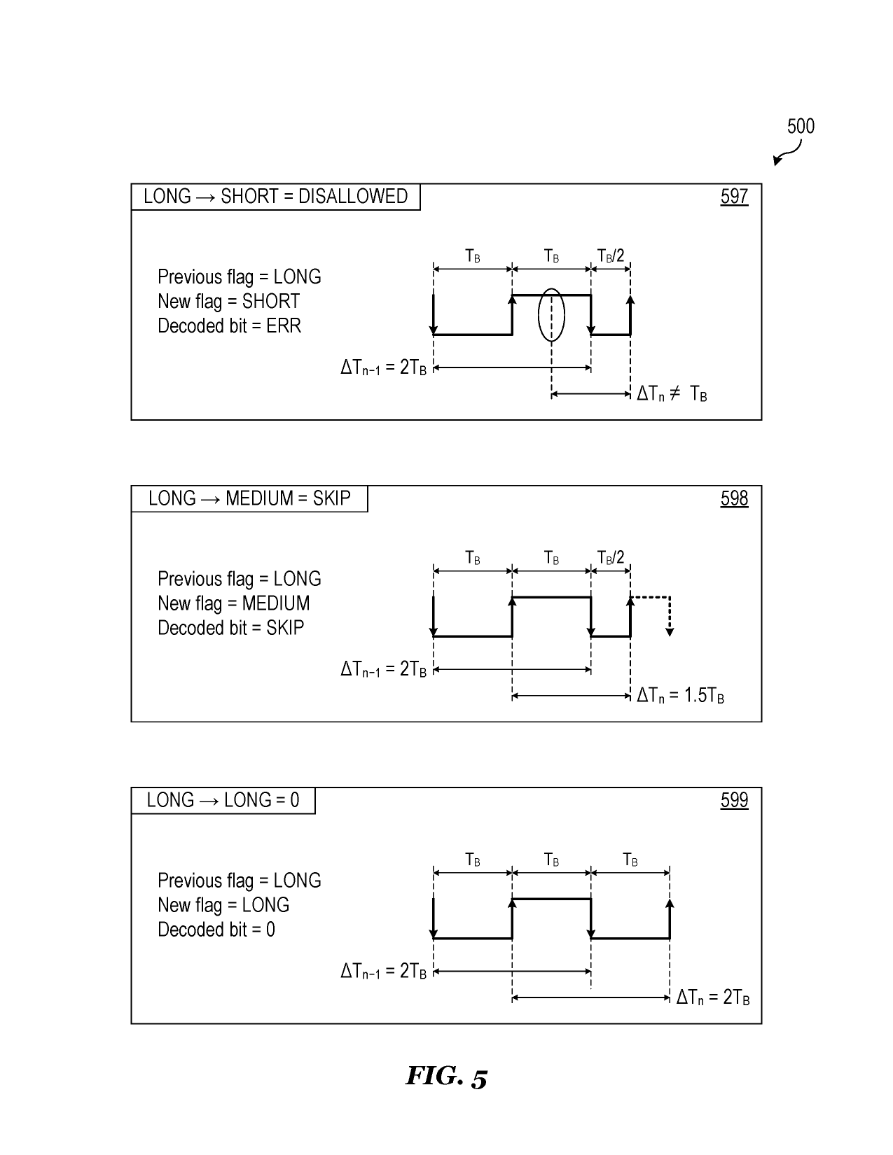

FIG. 5 illustrates schematic timing diagrams showing each possible scenario for the new flag when the previous flag is LONG to demonstrate an example method of decoding a new bit of a BMC encoded signal in accordance with embodiments of the invention. The schematic timing diagrams of FIG. 5 may correspond to methods steps of any of the methods described herein, such as the method of FIG. 10, for example.

Referring to FIG. 5, timing diagrams 500 show the sequence of the previous flag and the new flag as (LONG, SHORT) in box 597, the sequence of the previous flag and the new flag as (LONG, MEDIUM) in box 598, and the sequence of the previous flag and the new flag as (LONG, LONG) in box 599.

As shown in the box 597, a LONG flag followed by a SHORT flag is disallowed because a required transition would be skipped, similar to the (SHORT, LONG) scenario. In the case of the box 598, the previous flag being LONG forces the middle interval to be T_{B} which causes the most recent interval to be T_{B}/2. This situation is similar to that of (MEDIUM, MEDIUM), and the new bit is either skipped or is decoded as ‘1’ and the decoder skips decoding the next bit. Finally, the new flag being LONG causes the most recent interval to be T_{B} and the new bit is decoded as ‘0’, which is shown the box 599.

It should be noted that while the scenarios described using FIGS. 3–5 identify the decoded bit solely on the basis of the previous flag and the new flag, the decoded bit may also depend on the previous decoded bit (e.g., for practical reasons related to identifying the current position within the bitstream). For example, knowing the value of the previous decoded bit may not be mathematically necessary for determining the value of the current decoded bit, but it may be desirable to know exactly when to start a new bit decoding. Since for BMC encoded bitstreams, the clock is not explicitly provided, a starting point may be desirable to align the decoding to the data stream. In this situation, the window within which the decoding of the current bit is starting may need to be determined in order to decode a new bit. This is because if the window changes, the same combination of previous flags and new flags can result in two different scenarios. Values of the previous decoded bit and the new decoded bit are described below using FIGS. 6 and 7 for the scenarios discussed using FIGS. 3–5.

FIG. 6 illustrates a table summarizing the decoded values of the previous bit and the new bit for each possible pair of consecutive flags using a first type of BMC encoding in accordance with embodiments of the invention. The table of FIG. 6 may summarize decoding during any of the methods described herein, such as the method of FIG. 10, for example.

Referring to FIG. 6, a table 600 shows the previous and new decoded bits for each of the possible sequences of previous and new flags. In this specific example, a mid-bit transition is decoded as a ‘1’ bit while no transition during the bit duration is decoded as a ‘0’ bit.

Specifically, a previous bit 662 is decoded when evaluating the first flag (the previous flag) and a new bit 661 is decoded when evaluating the new flag. As shown, the decoded bit stays the same for some combinations: (SHORT, SHORT), (MEDIUM, LONG), and (LONG, LONG). In contrast, the decoded bit changes for other combinations: (SHORT, MEDIUM) and (MEDIUM, SHORT). Again, two sequences are disallowed, (SHORT, LONG) and (LONG, SHORT) which results in no decoded bit and/or an error being generated. The allowed situations that result in a skipped bit are (MEDIUM, MEDIUM) and (MEDIUM, LONG), which were previously discussed and shown as “0…1” rather than the arrow of the direct bit sequences.

FIG. 7 illustrates a table summarizing the decoded values of the previous bit and the new bit for each possible pair of consecutive flags using a second type of BMC encoding in accordance with embodiments of the invention. The table of FIG. 7 may summarize decoding during any of the methods described herein, such as the method of FIG. 10, for example.

Referring to FIG. 7, a table 700 shows the previous and new decoded bits for each of the possible sequences of previous and new flags for the opposite type of BMC encoding where a mid-bit transition is decoded as a ‘0’ bit and no transition during the bit duration is decoded as a ‘1’ bit. As before, a previous bit 762 is decoded when evaluating the first flag (the previous flag) and a new bit 761 is decoded when evaluating the new flag.

As can be seen from comparing the table 600 and the table 700, the same pattern is present for both types of BMC encoding, but the binary bit values are switched between the two tables. This allows the general behavior of a method of decoding a BMC encoded signal that corresponds with both tables to be described by indicating whether or not the decoded bit changes.

For example, in one embodiment, the previous flag is set to SHORT, the previous bit of the BMC encoded signal is decoded, the new flag is set to SHORT, and the new bit is decoded as the same binary value as the previous bit according to the sequence of the previous flag and the new flag as (SHORT, SHORT). Specifically, this describes the behavior of the (SHORT, SHORT) box for both tables.

In some embodiments, the previous flag is set to SHORT or MEDIUM, the previous bit of the BMC encoded signal is decoded, the new flag is set to MEDIUM or SHORT, and the new bit is decoded as a different binary value than the previous bit according to the sequence of the previous flag and the new flag as (SHORT, MEDIUM) or (MEDIUM, SHORT). In one embodiment, the sequence of the previous bit and the new bit is (MEDIUM, SHORT), a second most recent flag is set to MEDIUM or LONG according to the third most recent interval and the fourth most recent interval of the BMC encoded signal, and the decoding of a bit is skipped according to the sequence of the second most recent flag and the previous flag as (MEDIUM, MEDIUM) or (LONG, MEDIUM).

In other embodiments, the previous bit of the BMC encoded signal is decoded, the previous flag is set to MEDIUM or LONG, the new flag is set to MEDIUM, the new bit is decoded as a different value than the previous bit according to the sequence of the previous flag and the new flag as (MEDIUM, MEDIUM) or (LONG, MEDIUM), and the decoding of the next bit of the BMC encoded signal is skipped.

In some embodiments, the previous flag is set to MEDIUM or LONG, the previous bit of the BMC encoded signal is decoded, the new flag is set to LONG, and the new bit is decoded as the same binary value as the previous bit according to the sequence of the previous flag and the new flag as (MEDIUM, LONG) or (LONG, LONG).

In some embodiments, the new flag is set to SHORT or LONG, the new bit is decoded, a next flag is set to LONG or SHORT according to the first most recent interval and a next interval of the BMC encoded signal, and an error is generated when decoding a next bit of the BMC encoded signal after the new bit according to the sequence of the new flag and the next flag as (SHORT, LONG) or (LONG, SHORT).

FIG. 8 illustrates a schematic block diagram of an example BMC decoder circuit that includes a lower threshold circuit, an upper threshold circuit, and a BMC state machine circuit configured to decode bits of a BMC encoded signal according to pairs of flags set according to a lower threshold and an upper threshold in accordance with embodiments of the invention. The BMC decoder circuit may be used to perform any of the methods described herein, such as the method of FIG. 10, and may be included in any system described herein, such as the receiver of FIG. 9, as examples.

Referring to FIG. 8, a BMC decoder circuit 870 includes an edge detector circuit 878 configured to receive an BMC encoded signal 860 and output a signal indicating detection if a signal edge to a time interval circuit 877. The time interval circuit 877 is configured to determine the duration of time as an interval between a detected leading edge and a detected trailing edge. For example, the time interval circuit 877 may be configured to determine the first most recent interval using the n transition and the n-1 transition of the BMC encoded signal for each iteration, making the second most recent interval depend on the n-1 interval and the n-2 interval, the third most recent interval depend on the n-2 interval and the n-3 interval, and so on.

The intervals determined by the time interval circuit 877 are provided to a flag interval circuit 876 which generates a flag interval at an output indicating the total duration of a previous interval 839 and a current interval 834. For example, the flag interval circuit 876 may receive a time interval from the time interval circuit 877 and check whether there is a previous interval already stored. If so, the flag interval circuit 876 may store the incoming interval as the current interval 834 and generate a flag interval at the output. The flag interval circuit 876 determine each flag interval as equal to the sum of the current interval 834 and the previous interval 839 (i.e., the first most recent interval and the second most recent interval).

If there is no interval stored as the previous interval 839, then the flag interval circuit 876 may consider the incoming interval to be the first interval of the BMC encoded signal 860 and may store the incoming interval as the previous interval 839. In this way each new flag interval is determined using a second most recent interval and a first most recent interval that are generated by the time interval circuit 877 from transitions (detected edges) of the BMC encoded signal 860. For this reason, the previous flag interval was determined using a third most recent interval and the second most recent interval and so on.

Each flag interval provided at an output of the flag interval circuit 876 is compared to both a lower threshold using a lower threshold circuit 871 to generate a lower threshold output signal 872 and to an upper threshold using an upper threshold circuit 873 to generate an upper threshold output signal 874. In some implementations, the lower threshold circuit 871 and the upper threshold circuit 873 may be configured in sequence and one of the threshold circuits may be bypassed when the flag interval meets a criterion that conclusively determines the relationship to the other threshold.

The lower threshold circuit 871 is configured to compare each new flag interval to a lower threshold Th₁ to generate the lower threshold output signal 872. The upper threshold circuit 873 is configured to compare each new flag interval to an upper threshold Th₂ to generate the upper threshold output signal 874. As the BMC decoder circuit 870 iterates through new transitions of the BMC encoded signal 860, the new flag interval becomes the previous flag interval for the next decoded bit. Therefore, the lower threshold circuit 871 and the upper threshold circuit 873 are also configured to compare the previous flag interval to the lower threshold Th₁ the upper threshold Th₂ (in the previous iteration).

The BMC decoder circuit 870 further includes an BMC state machine circuit 875 that stores a previous flag 351 and a new flag 350 (similar to the previous interval 839 and the current interval 834 of the flag interval circuit 876) and decodes a new bit based on the values of the previous flag 351 and the new flag 350 to generate an output bitstream 866. The BMC state machine circuit 875 is configured to set the new flag according to the lower threshold Th₁ and the upper threshold Th₂ (e.g., by virtue of the new flag interval being subject to a double threshold comparison step).

FIG. 9 illustrates a schematic block diagram of an example receiver that includes a signal processing circuit and a BMC decoder circuit configured to decode bits of a BMC encoded signal according to pairs of flags set according to a lower threshold and an upper threshold in accordance with embodiments of the invention. The receiver may be used to perform any of the methods described herein, such as the method of FIG. 10, for example.

Referring to FIG. 9, a receiver 900 includes demodulator circuit 987 that includes a signal processing circuit 988 with an ADC circuit 980 (an analog-to-digital converter circuit). The signal processing circuit 988 is configured to receive a modulated BMC encoded signal 964 and output a digital BMC encoded signal 960 to a BMC decoder circuit 970 of the demodulator circuit 987. As before, the BMC decoder circuit 970 is configured to set a flags according to pairs of recent intervals defined by detected transitions of the BMC encoded signal 960 and decode a new bit of the BMC encoded signal 960 according to a previous flag and a new flag to generate an output bitstream 966.

In one embodiment, the demodulator circuit 987 is part of a wireless power transmitter. The signal processing circuit 988 may also include one or more of an IQ mixer circuit 981 (an in-phase and quadrature mixer circuit)that is coupled to the ADC circuit 980, a low-pass filter 982 coupled between the IQ mixer circuit 981 and the BMC decoder circuit 970, a DC removal circuit 984 (a direct current removal circuit, such as a high-pass filter) coupled between the IQ mixer circuit 981 and the BMC decoder circuit 970, and a slicer circuit 985 coupled to the BMC decoder circuit 970.

In some cases it may be desirable to process magnitude and phase signals (rather than in-phase and quadrature signals). In one embodiment, the signal processing circuit 988 includes an IQ-to-MP conversion circuit 983 (e.g., between the low-pass filter 982 and the DC removal circuit 984) that is configured to convert in-phase and quadrature signals into corresponding magnitude and phase (MP) signals.

FIG. 10 illustrates an example method of decoding a BMC encoded signal that includes setting a previous flag according to third and second most recent intervals between transitions of the BMC encoded signal, setting a new flag according to second and first most recent intervals of the BMC encoded signal, and decoding a new bit of the BMC encoded signal according to the previous flag and the new flag in accordance with embodiments of the invention. The method of FIG. 10 may be combined with other methods and performed using the systems and apparatuses as described herein. For example, the method of FIG. 10 may be combined with any of the embodiments of FIGS. 1–9. Although shown in a logical order, the arrangement and numbering of the steps of FIG. 10 are not intended to be limited. The method steps of FIG. 10 may be performed in any suitable order or concurrently with one another as may be apparent to a person of skill in the art.

Referring to FIG. 10, a method 1000 of decoding a BMC encoded signal includes a step of setting a previous flag according to a third most recent interval and a second most recent interval, the third most recent interval separating a first transition and a second transition of the BMC encoded signal and the second most recent interval separating the second transition and a third transition of the BMC encoded signal (box 101). The previous flag is based on two time intervals: the third most recent interval and the second most recent time interval. The intervals themselves may be determined during the method 1000 by iterating procedure (box 104) during which a leading transition of the interval is detected (box 105), a trailing transition of the interval is detected (box 106), and the time between the leading and trailing transitions is detected (box 107). Since the trailing transition and the leading transition of consecutive intervals are the same transition, the leading transition may not be detected each time (having already been detected as the trailing transition of the previous interval).

The previous flag may be based on a flag interval that is determined using the current interval and the previous interval (box 108). For example, the flag interval may be the sum of the current interval and the previous interval. In the specific case of determining the previous flag, a previous flag interval ΔT_{n−1}= T_{n−1}+ T_{n−2} may be determined where T_{n−1} is the second most recent interval and T_{n−2} is the third most recent interval.

A double threshold comparison step may then be performed on the flag interval to determine how to set the flag (box 109). For example, the flag interval may be compared to a lower threshold and an upper threshold (i.e., the threshold values are different, so they may be designated lower and upper respectively). Although the double threshold comparison step uses both thresholds for each comparison in general, a specific iteration of the double threshold comparison step may not always use both thresholds. For example, in some implementations of the method 1000 the flag interval may be compared to the lower threshold and the upper threshold consecutively. If the flag interval is lower than the lower threshold, then the SHORT flag may be given with no need to compare the flag interval to the upper threshold. Similarly, the opposite may also be true if the flag interval is compared to the upper threshold first. In various embodiments, the flag interval is compared to the lower threshold and the upper threshold every iteration of the double threshold comparison step (e.g., in parallel).

The method 1000 further includes a step of setting a new flag according to the second most recent interval and a first most recent interval separating the third transition and a fourth transition of the BMC encoded signal (box 102). The step of setting the new flag is similar to the step of setting the previous flag except that the intervals that are considered are different. That is, whereas the third and second most recent intervals are considered when setting the previous flag, the second and first most recent intervals are considered when setting the new flag.

Once both the previous flag and the new flag are set, a new bit of the BMC encoded signal is decoded according to the set values of the flags (box 103). For example, the sequence of the previous flag and the new flag may be used to determine the appropriate decoded value of the new bit. Details of the decoding of the new bit (and other bits in some cases) are described in the examples herein, such as using FIGS. 3–7, for example. Of course, the method 1000 may be iterated (indicated as arrow 119) so that the next iteration decodes the next bit, and so on.

While this invention has been described in the context of wireless communication, applications of the inventive concept are not limited thereto. The encoding scheme's inherent advantages extend beyond wireless contexts to various wired interfaces. Many benefits of BMC in wired applications may mirror those in wireless contexts: excellent clock recovery capability, no DC component (enabling transformer or capacitor coupling), reasonable bandwidth efficiency, and inherent error detection (which may be enhanced by the methods proposed herein).

BMC encoding is used in several important non-wireless serial communication applications. For example, BMC forms the foundation of the S/PDIF (Sony/Philips Digital Interface Format) and AES/EBU (Audio Engineering Society/European Broadcasting Union) digital audio interfaces, where it is implemented as part of a larger encoding scheme called “biphase mark channel coding.” These standards are ubiquitous in consumer and professional audio equipment for transmitting digital audio over coaxial or optical cables. BMC is also utilized in the professional MIDI (Musical Instrument Digital Interface) Time Code protocol for synchronization between audio devices. Additionally, certain magnetic storage systems have employed BMC for data encoding on tape drives due to its self-clocking properties and DC balance characteristics. Some industrial fieldbus protocols incorporate BMC variants for noise-resistant communication in electrically noisy factory environments.

Example embodiments of the invention are summarized here. Other embodiments can also be understood from the entirety of the specification as well as the claims filed herein.

Example 1. A method of decoding a BMC encoded signal, the method including: setting a previous flag according to a third most recent interval and a second most recent interval, the third most recent interval separating a first transition and a second transition of the BMC encoded signal and the second most recent interval separating the second transition and a third transition of the BMC encoded signal; setting a new flag according to the second most recent interval and a first most recent interval separating the third transition and a fourth transition of the BMC encoded signal; and decoding a new bit of the BMC encoded signal according to the previous flag and the new flag.

Example 2. The method of example 1, further including: determining a previous flag interval equal to the sum of the third most recent interval and the second most recent interval, where setting the previous flag includes comparing the previous flag interval to a lower threshold and an upper threshold, both the lower threshold and the upper threshold being greater than a BMC bit duration of the BMC encoded signal; and determining a new flag interval equal to the sum of the second most recent interval and the first most recent interval, where setting the new flag includes comparing the new flag to the lower threshold and the upper threshold.

Example 3. The method of example 2, where each of setting the previous flag and setting the new flag includes setting a respective flag to a first label (SHORT) when the respective flag interval is less than or equal to the lower threshold, setting the respective flag to a second label (MEDIUM) when the respective flag interval is between the lower threshold and the upper threshold, and setting the respective flag to a third label (LONG) when the respective flag interval is greater than or equal to the upper threshold.

Example 4. The method of example 3, further including: decoding a previous bit of the BMC encoded signal; where the previous flag is set to SHORT; where the new flag is set to SHORT; and where the new bit is decoded as the same binary value as the previous bit according to the sequence of the previous flag and the new flag as (SHORT, SHORT).

Example 5. The method of one of examples 3 and 4, further including: decoding a previous bit of the BMC encoded signal; where the previous flag is set to SHORT or MEDIUM; where the new flag is set to MEDIUM or SHORT; and where the new bit is decoded as a different binary value than the previous bit according to the sequence of the previous flag and the new flag as (SHORT, MEDIUM) or (MEDIUM, SHORT).

Example 6. The method of example 5, further including: setting a second most recent flag as MEDIUM or LONG according to the third most recent interval and a fourth most recent interval separating a fifth transition of the BMC encoded signal and the first transition; skipping decoding of a bit according to the sequence of the second most recent flag and the previous flag as (MEDIUM, MEDIUM) or (LONG, MEDIUM), the previous flag being set to MEDIUM, and the new flag being set to SHORT; and where the new bit is decoded as the different binary value according to the sequence of the previous flag and the new flag as (MEDIUM, SHORT).

Example 7. The method of one of examples 3 to 6, further including: decoding a previous bit of the BMC encoded signal; where the previous flag is set to MEDIUM or LONG; where the new flag is set to LONG; and where the new bit is decoded as the same binary value as the previous bit according to the sequence of the previous flag and the new flag as (MEDIUM, LONG) or (LONG, LONG).

Example 8. The method of one of examples 3 to 7, further including: decoding a previous bit of the BMC encoded signal; skipping decoding of the next bit of the BMC encoded signal after the new bit; where the previous flag is set to MEDIUM or LONG; where the new flag is set to MEDIUM; and where the new bit is decoded as a different binary value than the previous bit according to the sequence of the previous flag and the new flag as (MEDIUM, MEDIUM) or (LONG, MEDIUM).

Example 9. The method of one of examples 3 to 8, further including: setting a next flag as LONG or SHORT according to the first most recent interval and a next interval separating the fourth transition and a fifth transition of the BMC encoded signal, the new flag being set to SHORT or LONG; and generating an error when decoding a next bit of the BMC encoded signal after the new bit according to the sequence of the new flag and the next flag as (SHORT, LONG) or (LONG, SHORT).

Example 10. A BMC decoder circuit including: a lower threshold circuit configured to compare a new flag interval to a lower threshold to generate a lower threshold output signal, where the new flag interval is determined using a second most recent interval and a first most recent interval, the second most recent interval separating a first transition and a second transition of a BMC encoded signal and the first most recent interval separating the second transition and a third transition of the BMC encoded signal; an upper threshold circuit configured to compare the new flag interval to an upper threshold to generate an upper threshold output signal; and a BMC state machine circuit configured to set a new flag according to the lower threshold output signal and the upper threshold output signal; and decode a new bit of the BMC encoded signal according to a previous flag and the new flag.

Example 11. The BMC decoder circuit of example 10, where the lower threshold circuit is further configured to compare a previous flag interval to the lower threshold to generate a previous lower threshold output signal, where the previous flag interval is determined using the second most recent interval and a third most recent interval separating a previous transition and the first transition of the BMC encoded signal, the upper threshold circuit is further configured to compare the previous flag interval to the upper threshold to generate a previous upper threshold output signal, and the BMC state machine circuit is further configured to set the previous flag according to the previous lower threshold output signal and the previous upper threshold output signal.

Example 12. The BMC decoder circuit of example 11, where the BMC state machine circuit is configured to set a respective flag to a first label (SHORT) when the respective flag interval is less than or equal to the lower threshold, set the respective flag to a second label (MEDIUM) when the respective flag interval is between the lower threshold and the upper threshold, and set the respective flag to a third label (LONG) when the respective flag interval is greater than or equal to the upper threshold.

Example 13. The BMC decoder circuit of one of examples 11 and 12, further including: a flag interval circuit configured to determine the previous flag interval as equal to the sum of the third most recent interval and the second most recent interval, and determine the new flag interval as equal to the sum of the second most recent interval and the first most recent interval.

Example 14. The BMC decoder circuit of example 13, further including: a time interval circuit configured to determine the third most recent interval using the previous transition and the first transition of the BMC encoded signal, determine the second most recent interval using the first transition and the second transition of the BMC encoded signal, and determine the first most recent interval using the second transition and the third transition of the BMC encoded signal.

Example 15. A demodulator circuit including: a signal processing circuit including an ADC circuit, the signal processing circuit being configured to receive a modulated BMC encoded signal and output a digital BMC encoded signal; and a BMC decoder circuit configured to set a previous flag according to a third most recent interval and a second most recent interval, the third most recent interval separating a first transition and a second transition of the digital BMC encoded signal and the second most recent interval separating the second transition and a third transition of the digital BMC encoded signal, set a new flag according to the second most recent interval and a first most recent interval separating the third transition and a fourth transition of the digital BMC encoded signal, and decode a new bit of the digital BMC encoded signal according to the previous flag and the new flag.

Example 16. The demodulator circuit of example 15, where the BMC decoder circuit includes: a lower threshold circuit configured to compare a new flag interval to a lower threshold to generate a lower threshold output signal, where the new flag interval is determined using the second most recent interval and the first most recent interval; an upper threshold circuit configured to compare the new flag interval to an upper threshold to generate an upper threshold output signal; and a BMC state machine circuit configured to set the new flag according to the lower threshold output signal and the upper threshold output signal, and decode the new bit.

Example 17. The demodulator circuit of example 16, where the lower threshold circuit is further configured to compare a previous flag interval to the lower threshold to generate a previous lower threshold output signal, where the previous flag interval is determined using the second most recent interval and the third most recent interval, the upper threshold circuit is further configured to compare the previous flag interval to the upper threshold to generate a previous upper threshold output signal, and the BMC state machine circuit is further configured to set the previous flag according to the previous lower threshold output signal and the previous upper threshold output signal.

Example 18. The demodulator circuit of example 17, where the BMC state machine circuit is configured to set a respective flag to a first label (SHORT) when the respective flag interval is less than or equal to the lower threshold, set the respective flag to a second label (MEDIUM) when the respective flag interval is between the lower threshold and the upper threshold, and set the respective flag to a third label (LONG) when the respective flag interval is greater than or equal to the upper threshold.

Example 19. The demodulator circuit of one of examples 15 to 18, where the demodulator circuit is part of a wireless power transmitter, and the signal processing circuit further includes an IQ mixer circuit coupled to the ADC circuit, a low-pass filter coupled between the IQ mixer circuit and the BMC decoder circuit, a direct current (DC) removal circuit coupled between the IQ mixer circuit and the BMC decoder circuit, and a slicer circuit coupled to the BMC decoder circuit.

Example 20. The demodulator circuit of example 19, where the signal processing circuit further includes an IQ-to-MP conversion circuit coupled between the low-pass filter and the DC removal circuit and configured to convert input in-phase and quadrature signals into corresponding MP signals.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of decoding a biphase mark code (BMC) encoded signal, the method comprising:
setting a previous flag according to a third most recent interval and a second most recent interval, the third most recent interval separating a first transition and a second transition of the BMC encoded signal and the second most recent interval separating the second transition and a third transition of the BMC encoded signal;
setting a new flag according to the second most recent interval and a first most recent interval separating the third transition and a fourth transition of the BMC encoded signal; and
decoding a new bit of the BMC encoded signal according to the previous flag and the new flag.

2. The method of claim 1, further comprising:
determining a previous flag interval equal to the sum of the third most recent interval and the second most recent interval, wherein setting the previous flag comprises
comparing the previous flag interval to a lower threshold and an upper threshold, both the lower threshold and the upper threshold being greater than a BMC bit duration of the BMC encoded signal; and
determining a new flag interval equal to the sum of the second most recent interval and the first most recent interval, wherein setting the new flag comprises
comparing the new flag to the lower threshold and the upper threshold.

3. The method of claim 2, wherein each of setting the previous flag and setting the new flag comprises
setting a respective flag to a first label (SHORT) when the respective flag interval is less than or equal to the lower threshold,
setting the respective flag to a second label (MEDIUM) when the respective flag interval is between the lower threshold and the upper threshold, and
setting the respective flag to a third label (LONG) when the respective flag interval is greater than or equal to the upper threshold.

4. The method of claim 3, further comprising:
decoding a previous bit of the BMC encoded signal;
wherein the previous flag is set to SHORT;
wherein the new flag is set to SHORT; and
wherein the new bit is decoded as the same binary value as the previous bit according to the sequence of the previous flag and the new flag as (SHORT, SHORT).

5. The method of claim 3, further comprising:
decoding a previous bit of the BMC encoded signal;
wherein the previous flag is set to SHORT or MEDIUM;
wherein the new flag is set to MEDIUM or SHORT; and
wherein the new bit is decoded as a different binary value than the previous bit according to the sequence of the previous flag and the new flag as (SHORT, MEDIUM) or (MEDIUM, SHORT).

6. The method of claim 5, further comprising:
setting a second most recent flag as MEDIUM or LONG according to the third most recent interval and a fourth most recent interval separating a fifth transition of the BMC encoded signal and the first transition;
skipping decoding of a bit according to the sequence of the second most recent flag and the previous flag as (MEDIUM, MEDIUM) or (LONG, MEDIUM), the previous flag being set to MEDIUM, and the new flag being set to SHORT; and
wherein the new bit is decoded as the different binary value according to the sequence of the previous flag and the new flag as (MEDIUM, SHORT).

7. The method of claim 3, further comprising:
decoding a previous bit of the BMC encoded signal;
wherein the previous flag is set to MEDIUM or LONG;
wherein the new flag is set to LONG; and
wherein the new bit is decoded as the same binary value as the previous bit according to the sequence of the previous flag and the new flag as (MEDIUM, LONG) or (LONG, LONG).

8. The method of claim 3, further comprising:
decoding a previous bit of the BMC encoded signal;
skipping decoding of the next bit of the BMC encoded signal after the new bit;
wherein the previous flag is set to MEDIUM or LONG;
wherein the new flag is set to MEDIUM; and
wherein the new bit is decoded as a different binary value than the previous bit according to the sequence of the previous flag and the new flag as (MEDIUM, MEDIUM) or (LONG, MEDIUM).

9. The method of claim 3, further comprising:
setting a next flag as LONG or SHORT according to the first most recent interval and a next interval separating the fourth transition and a fifth transition of the BMC encoded signal, the new flag being set to SHORT or LONG; and
generating an error when decoding a next bit of the BMC encoded signal after the new bit according to the sequence of the new flag and the next flag as (SHORT, LONG) or (LONG, SHORT).

10. A biphase mark code (BMC) decoder circuit comprising:
a lower threshold circuit configured to compare a new flag interval to a lower threshold to generate a lower threshold output signal,
wherein the new flag interval is determined using a second most recent interval and a first most recent interval, the second most recent interval separating a first transition and a second transition of a BMC encoded signal and the first most recent interval separating the second transition and a third transition of the BMC encoded signal;
an upper threshold circuit configured to compare the new flag interval to an upper threshold to generate an upper threshold output signal; and
a BMC state machine circuit configured to
set a new flag according to the lower threshold output signal and the upper threshold output signal; and
decode a new bit of the BMC encoded signal according to a previous flag and the new flag.

11. The BMC decoder circuit of claim 10, wherein
the lower threshold circuit is further configured to compare a previous flag interval to the lower threshold to generate a previous lower threshold output signal,
wherein the previous flag interval is determined using the second most recent interval and a third most recent interval separating a previous transition and the first transition of the BMC encoded signal,
the upper threshold circuit is further configured to compare the previous flag interval to the upper threshold to generate a previous upper threshold output signal, and
the BMC state machine circuit is further configured to set the previous flag according to the previous lower threshold output signal and the previous upper threshold output signal.

12. The BMC decoder circuit of claim 11, wherein the BMC state machine circuit is configured to
set a respective flag to a first label (SHORT) when the respective flag interval is less than or equal to the lower threshold,
set the respective flag to a second label (MEDIUM) when the respective flag interval is between the lower threshold and the upper threshold, and
set the respective flag to a third label (LONG) when the respective flag interval is greater than or equal to the upper threshold.

13. The BMC decoder circuit of claim 11, further comprising:
a flag interval circuit configured to
determine the previous flag interval as equal to the sum of the third most recent interval and the second most recent interval, and
determine the new flag interval as equal to the sum of the second most recent interval and the first most recent interval.

14. The BMC decoder circuit of claim 13, further comprising:
a time interval circuit configured to
determine the third most recent interval using the previous transition and the first transition of the BMC encoded signal,
determine the second most recent interval using the first transition and the second transition of the BMC encoded signal, and
determine the first most recent interval using the second transition and the third transition of the BMC encoded signal.

15. A demodulator circuit comprising:
a signal processing circuit comprising an analog-to-digital converter (ADC) circuit, the signal processing circuit being configured to receive a modulated BMC encoded signal and output a digital BMC encoded signal; and
a BMC decoder circuit configured to
set a previous flag according to a third most recent interval and a second most recent interval, the third most recent interval separating a first transition and a second transition of the digital BMC encoded signal and the second most recent interval separating the second transition and a third transition of the digital BMC encoded signal,
set a new flag according to the second most recent interval and a first most recent interval separating the third transition and a fourth transition of the digital BMC encoded signal, and
decode a new bit of the digital BMC encoded signal according to the previous flag and the new flag.

16. The demodulator circuit of claim 15, wherein the BMC decoder circuit comprises:
a lower threshold circuit configured to compare a new flag interval to a lower threshold to generate a lower threshold output signal,
wherein the new flag interval is determined using the second most recent interval and the first most recent interval;
an upper threshold circuit configured to compare the new flag interval to an upper threshold to generate an upper threshold output signal; and
a BMC state machine circuit configured to set the new flag according to the lower threshold output signal and the upper threshold output signal, and decode the new bit.

17. The demodulator circuit of claim 16, wherein
the lower threshold circuit is further configured to compare a previous flag interval to the lower threshold to generate a previous lower threshold output signal,
wherein the previous flag interval is determined using the second most recent interval and the third most recent interval,
the upper threshold circuit is further configured to compare the previous flag interval to the upper threshold to generate a previous upper threshold output signal, and
the BMC state machine circuit is further configured to set the previous flag according to the previous lower threshold output signal and the previous upper threshold output signal.

18. The demodulator circuit of claim 17, wherein the BMC state machine circuit is configured to
set a respective flag to a first label (SHORT) when the respective flag interval is less than or equal to the lower threshold,
set the respective flag to a second label (MEDIUM) when the respective flag interval is between the lower threshold and the upper threshold, and
set the respective flag to a third label (LONG) when the respective flag interval is greater than or equal to the upper threshold.

19. The demodulator circuit of claim 15, wherein
the demodulator circuit is part of a wireless power transmitter, and
the signal processing circuit further comprises
an in-phase and quadrature (IQ) mixer circuit coupled to the ADC circuit,
a low-pass filter coupled between the IQ mixer circuit and the BMC decoder circuit,
a direct current (DC) removal circuit coupled between the IQ mixer circuit and the BMC decoder circuit, and
a slicer circuit coupled to the BMC decoder circuit.

20. The demodulator circuit of claim 19, wherein the signal processing circuit further comprises an IQ-to-MP conversion circuit coupled between the low-pass filter and the DC removal circuit and configured to convert input in-phase and quadrature signals into corresponding magnitude and phase (MP) signals.
